(19) United States
(12) Patent Application Publication
(10) Pub. No.: US 2026/0369440 A1
(43) Pub. Date: Nov. 19, 2026

(54) SYSTEM AND METHOD FOR PRODUCING RADIOISOTOPES IN NUCLEAR POWER REACTORS

(71) Applicant: CANDU ENERGY INC., Mississauga (CA)

(72) Inventors: William Henry COOPER, Rothesay (CA); Robert John ORR, Tiny (CA)

(21) Appl. No.: 19/674,896

(22) Filed: May 12, 2026

Related U.S. Application Data
(60) Provisional application No. 63/806,401, filed on May 15, 2025.

(51) Int. Cl. G21G 1/02; G21G 1/00

(52) U.S. Cl. CPC G21G 1/02; G21G 1/001

(57) ABSTRACT

A system and method for producing radioisotopes in a nuclear reactor having a reactor core is provided. The system comprises a guide tube defining an irradiation zone within the guide tube for receiving a precursor, the guide tube extending into an inner volume of the reactor core, and the irradiation zone defining a distinct environment from an environment of the reactor core exterior to the guide tube. A cooling system is provided for circulating a heat transfer medium through the irradiation zone of the guide tube; and a delivery system is provided for moving the precursor from a first position outside the inner volume of the reactor core to a second position within the inner volume of the reactor core. The first position of the precursor is outside the inner volume of the reactor core.

### CROSS REFERENCE TO RELATED APPLICATION AND CLAIM OF PRIORITY

The present application claims priority to U.S. provisional patent application no. 63/806,401 filed on May 15, 2025, the entire contents of which are hereby incorporated by reference.

### TECHNICAL FIELD

The disclosure relates generally to nuclear power reactors, and more particularly to production of radioisotopes in a power reactor.

### BACKGROUND

Radioisotopes commonly administered to patients in nuclear medicine are typically artificially produced via three production routes: (1) nuclear reactor reactions where the resulting nuclide has the same chemical properties as those of the target nuclide; (2) nuclear reactor fission followed by separation; and (3) charged particle induced reactions in cyclotrons or linear accelerators where the resulting nucleus is usually that of a different element.

Nuclear science processes that transform a precursor into a radioisotope include neutron capture, photonuclear reactions, fission and breeding. Different methods may be used for different medical isotopes of interest. Neutron capture involves a nucleus absorbing a neutron. Photonuclear reactions involve the interaction of photons with atomic nuclei, leading to nuclear transformation. Fission is the process where a nucleus splits, releasing radioisotopes as fission products. Breeding refers to creating new fissile material from fertile material, that then releases radioisotopes as fission products.

Radioisotope demand is growing; however, production of radioisotopes, such as medical isotopes, has and will be limited by the availability of isotope production facilities, typically in the form of research reactors, cyclotrons and linear accelerators.

Research reactors have historically been the major provider of radioisotopes where forced outages have caused the greatest impact, and facilities scheduled to reach end-of-life within the next few decades cause the most risk.

The Canadian Chalk River Laboratories NRU research reactor, which had been a major supplier of radioisotopes to the medical community, was shut down in 2007 for an extended maintenance and upgrade outage, followed by a forced shutdown in 2009 for more than a year due to equipment failure. The impact of the NRU research reactor shutdown was compounded by a maintenance shutdown of the High Flux Reactor in the Netherlands in 2010. In the six months that the two facilities were offline concurrently, the global imaging community lost 65 percent of its regular production of medical isotopes.

An expert review panel on medical isotope production was established in 2009 to advise the Government of Canada on the most viable options for securing a predictable and reliable medical isotope supply due to the NRU issues. The panel's work and recommendations were documented by Peter Goodhand et al., “Report of the Expert Review Panel on Medical Isotope Production,” Chapter 5.4, 30 Nov. 2009, Online https://www.cins.ca/docs/panrep-rapexp-eng.pdf (accessed May 6, 2025), the entire contents of which are hereby incorporated by reference. Although the panel contemplated producing radioisotopes in a limited number of fuel channels of a heavy water nuclear reactor, no owner/operator of a CANDU™ power plant expressed a willingness to pursue the idea.

Accordingly, improved and reliable supplies of radioisotopes are desired.

### SUMMARY

In one aspect, the disclosure describes a system for producing radioisotopes in a nuclear reactor having a reactor core. The system comprises: a guide tube defining an irradiation zone within the guide tube for receiving a precursor, the guide tube extending into an inner volume of the reactor core, and the irradiation zone defining a distinct environment from an environment of the reactor core exterior to the guide tube; a cooling system for circulating a heat transfer medium through the irradiation zone of the guide tube; and a delivery system for moving the precursor from a first position outside the inner volume of the reactor core to a second position within the inner volume of the reactor core, wherein the first position is outside the inner volume of the reactor core.

In an embodiment, the at least one precursor is configured to be converted into one or more radioisotopes selected from: actinium-225, actinium-227, americium-241, bismuth-212, bismuth-213, cadmium-109, caesium-131, caesium-137, californium-252, carbon-14, cerium-141, chromium-51, cobalt-60, copper-64, copper-67, dysprosium-165, dysprosium-166, erbium-169, europium-152, europium-154, europium-154, gadolinium-153, gold-198, holmium-166, iodine-125, iodine-131, iridium-192, iron-59, krypton-85, lead-212, lutetium-177, progenitor of lutetium-177, manganese-54, molybdenum-99, nickel-63, osmium-194, palladium-103, phosphorus-32, phosphorus-33, platinum-195m, plutonium-238, potassium-42, radium-223, rhenium-186, rhenium-188, rhodium-105, samarium-145, samarium-153, scandium-47, selenium-75, sodium-24, strontium-85, strontium-89, technetium-99m, terbium-161, thallium-204, thorium-226, thorium-227, thorium-228, thorium-229, thulium-170, tin-117m, tritium (H3), tungsten-188, xenon-127, xenon-133, ytterbium-169, ytterbium-175, ytterbium-177, yttrium-90, yttrium-91.

In an embodiment, the precursor is part of a target assembly.

In an embodiment, the target assembly is configured to provide an additive neutron flux and/or energy to convert the precursor into a radioisotope. In an example, the target assembly comprises a sleeve comprising fissile material and/or a moderator material, wherein the sleeve defines the precursor, wherein the target assembly is configured to provide peak radioisotope specific-activity for the radioisotope. In another example, the precursor is a first precursor; and the target assembly comprises a second precursor configured to convert into a different radioisotope than the first precursor.

In an embodiment, the target assembly comprises one or more target bundles including a plurality targets, wherein the precursor is a first precursor and the target assembly is a first target assembly, wherein the target bundle comprises an inner ring of elements and an outer ring of elements, wherein one of the inner ring or the outer ring comprises the first precursor, wherein the other of the inner ring or outer ring comprises at least one element comprising a reflector, a multiplier, or fissionable material. In an embodiment, the inner ring of elements comprises the reflector and the outer ring of elements comprise the precursor; or the inner ring of elements comprises the multiplier material and the outer ring of elements comprises the precursor; or the inner ring of elements comprises fissionable material and the outer ring comprises the precursor; or the precursor is a first precursor, and wherein the inner ring of elements comprises the reflector and the outer ring comprises a plurality of precursors, the plurality of precursors comprising the first precursor; or the inner ring of elements comprises the fissionable material and the outer ring of elements comprises the plurality of precursors, the plurality of precursors comprising the first precursor; or the inner ring of elements comprises the reflector and the outer ring of elements comprises the fissionable material and the precursor; or the inner ring of elements comprises the fissionable material and the outer ring of elements comprises the fissionable material and the precursor; or the inner ring of elements comprises the reflector and the outer ring of elements comprises a breeding target including fertile radioisotope material comprising the precursor; or the inner ring of elements comprises the multiplier material and the outer ring of elements comprises the breeding target including fertile radioisotope material comprising the precursor; or the inner ring of elements comprises the fissionable material and the outer ring of elements comprises the breeding target including fertile radioisotope material comprising the precursor.

In an embodiment, the nuclear reactor is a heavy water nuclear reactor, light water reactor and/or another type of power reactor design.

In an embodiment, the heat transfer medium is at least one of heavy water argon, helium, and light water.,

In an embodiment, the system comprises a controller configured to: send data to the delivery system to move the precursor from the first position outside the inner volume of the reactor core to the second position within the inner volume of the reactor core. In an embodiment, the controller is configured to: send data to the cooling system to circulate the heat transfer medium through the irradiation zone of the guide tube. In an embodiment, the cooling system comprises: a valve configured to control a flowrate of the heat transfer medium through the irradiation zone of the guide tube, and at least one of a temperature sensor and pressure sensor configured to sense temperature of the guide tube within the irradiation zone; wherein the controller sends data to the valve to circulate the heat transfer medium to maintain at least one of a desired temperature and pressure of the guide tube within the irradiation zone. In another embodiment, the precursor is a first precursor, and the controller is configured to: send data to the delivery system to move a second precursor from the first position outside the inner volume of the reactor core to the second position within the inner volume of the reactor core to irradiate both the first and second precursors concurrently. In another embodiment, the controller is configured to send data to the delivery system to move the first precursor from the second position within the inner volume of the reactor core to the first position outside the inner volume of the reactor core after the precursor is converted into a radioisotope.

Embodiments may include combinations of the above features.

In another aspect, the disclosure describes a nuclear reactor comprising a system according to this disclosure. The nuclear reactor comprising: a reactor core enclosure; a plurality of pressure tubes in the reactor core enclosure including fuel bundles, heavy water primary coolant flowing from outside of the reactor core enclosure through the plurality of pressure tubes, the reactor core enclosure including heavy water moderator separated from the plurality of pressure tubes; and a reactivity mechanism deck positioned above the reactor core enclosure, the reactivity mechanism deck including a port extending therethrough, the port housing the guide tube configured to convert the precursor into a radioisotope upon exposure to one or more nuclear science processes.

In an embodiment, the delivery system is a rack and pinion push rod mechanical delivery system.

In an embodiment, the delivery system may be at least one of a pneumatic delivery system, hydraulic delivery system, or mechanical delivery system, or any combination thereof.

Embodiments may include combinations of the above features.

In a further aspect, the disclosure describes a method for producing a radioisotope. The method comprising: inserting a target assembly into a guide tube extending into an inner volume of a reactor core of a nuclear reactor, the target assembly comprising a precursor, the guide tube defining an irradiation zone within the guide tube for receiving the precursor, the irradiation zone defining a distinct environment from the environment of the reactor core exterior to the guide tube; irradiating the precursor to convert the precursor into a radioisotope; and circulating a heat transfer medium in the irradiation zone to remove heat from the target assembly.

In an embodiment, the method comprises removing the target assembly comprising the radioisotope from the reactor core. The nuclear reactor, and reactor core thereof, may still be operating to produce power when the target assembly is removed from the reactor core.

In an embodiment, the radioisotope comprises: actinium-225, actinium-227, americium-241, bismuth-212, bismuth-213, cadmium-109, caesium-131, caesium-137, californium-252, carbon-14, cerium-141, chromium-51, cobalt-60, copper-64, copper-67, dysprosium-165, dysprosium-166, erbium-169, europium-152, europium-154, europium-154, gadolinium-153, gold-198, holmium-166, iodine-125, iodine-131, iridium-192, iron-59, krypton-85, lead-212, lutetium-177, progenitor of lutetium-177, manganese-54, molybdenum-99, nickel-63, osmium-194, palladium-103, phosphorus-32, phosphorus-33, platinum-195m, plutonium-238, potassium-42, radium-223, rhenium-186, rhenium-188, rhodium-105, samarium-145, samarium-153, scandium-47, selenium-75, sodium-24, strontium-85, strontium-89, technetium-99m, terbium-161, thallium-204, thorium-226, thorium-227, thorium-228, thorium-229, thulium-170, tin-117m, tritium (H3), tungsten-188, xenon-127, xenon-133, ytterbium-169, ytterbium-175, ytterbium-177, yttrium-90, and yttrium-91.

In an embodiment, the method comprises irradiating the precursor with additive neutron flux and/or energy within the guide tube. In an example, the target assembly comprises an sleeve comprising fissile material and/or moderator material, wherein the sleeve defines the precursor, wherein the target assembly is configured to provide peak specific-activity for the radioisotope.

In an embodiment, the heat transfer medium is at least one of heavy water argon, helium, and light water.

In an embodiment, the method comprises maintaining a first pressure within the guide tube at a greater pressure than second pressure within reactor core external to the guide tube.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a simplified schematic view of a nuclear steam supply system of an example CANDU™ type power reactor overlayed with a radioisotope production system according to this disclosure.

FIG. 2 is a cutaway view of a bare reactivity mechanism deck of a CANDU™ type power reactor showing a radioisotope production system nozzle for receiving a radioisotope production system according to this disclosure.

FIG. 3 is a perspective view of a CANDU™ type power reactor showing the radioisotope production system integrated with the power reactor.

FIG. 4A is a cross-section schematic view of a CANDU™ type power reactor comprising a system for producing radioisotopes positioned in relation to the calandria tubes of the heavy water nuclear reactor.

FIG. 4B is an upper cutaway plan view of target delivery and reactor integration sub-systems of the overall system for producing radioisotopes shown in FIG. 4A.

FIG. 4C is a lower cutaway plan view of target delivery, reactor integration and cooling feed sub-systems, including an example target assembly of the overall system for producing radioisotopes shown in FIG. 4A.

FIG. 5A is a perspective view of the example target assembly according to this disclosure.

FIG. 5B is a cross-section schematic view of the target assembly shown in FIG. 5A.

FIG. 5C is a cutaway and cross section view of a target bundle shown in FIG. 5A.

FIG. 6 shows versatility of the radioisotope production system with the species of radioisotopes that can be produced per nuclear science process method, in embodiments for the example target bundle.

FIG. 7 is a schematic diagram illustrating a method for radioisotope production in a nuclear reactor.

FIG. 8 shows a generalized schematic view of an example system for controlling a system to produce a radioisotope according to some embodiments.

### DETAILED DESCRIPTION

This disclosure provides a system and method for producing radioisotope(s) in a nuclear reactor also referred to herein as a “Versatile Isotope Production System”. Radioisotopes according to this disclosure may refer to medical isotopes for use in the field of nuclear medicine to diagnose, stage, and treat diseases, e.g. cancer and heart conditions, by imaging bodily functions or destroying tumor cells. Example medical isotopes include Technetium-99m and Cobalt-60. Radioisotopes according to this disclosure may also refer to industrial isotopes which are radioactive or stable atoms used in various sectors for monitoring, testing, and production. Example applications of industrial isotopes include non-destructive imaging of materials, thickness measurement in manufacturing, tracing, and sterilization, with Cobalt-60 and Iridium-192 being widely used in industrial radiography and sterilization. The system and method described in this disclosure utilize augmented and/or expanded application of nuclear science processes when installed in power reactors, and particularly in a heavy water reactor, for example in a CANDU™ type power reactor, that allows for a larger and broader production of radioisotopes due to a distinct irradiation zone compared to simply a neutron capture application within the same power reactor. Example nuclear science processes include neutron capture, photonuclear, fission, and breeding.

Systems according to this disclosure describe creating a distinct irradiation zone which enables radioisotopes to be produced in a power reactor, that historically were produced either in a research reactor, a linear accelerator or a cyclotron. By creating this distinct improved zone of irradiation in a power reactor, it transforms the power reactor into a cogeneration production facility that outputs both electricity and radioisotopes, with characteristics of a power reactor, a research reactor, a linear accelerator and a cyclotron, all in one.

This disclosure also utilizes a dedicated pass-through cooling path for the radioisotope production system to address the resulting increase in heat load from the augmented and/or expanded application of nuclear science processes within the radioisotope production system.

Prior art systems, such as those described in Canadian Patent Nos. 2986976 and 3109824, the entire contents of which are hereby incorporated by reference, simply utilize neutron capture from the neutron flux created by the power reactor core. However, these prior systems have a limit on the ceiling of the level of attainable specific-activity within the resulting radioisotope and also restrict the possible choice of radioisotopes, where a required threshold level is not available in the particular reactor design. Neither of the prior art systems, Canadian Patent No. 2986976 or 3109824, mention a guide tube extending into an inner volume of a nuclear reactor core, and an irradiation zone having a distinct environment from the rest of the reactor core exterior to the guide tube. In fact, an expert review panel in 2009, and the previous effort for radioisotope production described in Canadian Patent Application Nos. 2986976 and 3109824, use simple neutron capture, and do not attempt or mentioned using an distinct environment and zone of irradiation within the nuclear reactor core, separated from the environment of the heavy water nuclear reactor, to enable cogeneration of both electricity and radioisotopes. By creating a distinct irradiation zone, radioisotope production of certain medical isotopes is enabled in a power reactor, that historically were produced either in a research reactor, a linear accelerator or a cyclotron. The systems according to this disclose may transform the power reactor into a cogeneration production facility that outputs both electricity and radioisotopes, with characteristics of a power reactor, a research reactor, a linear accelerator and a cyclotron, all in one.

The system and method described in this disclosure may also provide the ability to create additional neutron flux and/or energy from reflector, multiplier, fissile or fertile material positioned within the system which is in addition to that created by the reactor core. This can provide the ability to provide additive neutron flux and/or energy to convert the precursor. By providing an additive source of neutron flux and/or energy for producing radioisotopes, reduction and moderation of the fluxes in the rest of the power reactor may be prevented or mitigated, and higher specific-activity and/or higher threshold isotopes can be produced.

In an aspect, the systems according to this disclosure may be installed in new build power reactors; or may be added to existing power reactors, for example in refurbishment outages; or be incorporated into power reactors not yet fully constructed, for example in completion projects. Production of a radioisotope, e.g. a medical isotope, in nuclear power reactors is a challenge because introduction of the precursor into the power reactor, and subsequent harvesting of the transformed precursor from the power reactor, could have operational impacts to the availability and reliability of electrical power production.

There has been almost 50 years of large-scale production of the radioisotope cobalt-60, in heavy water power reactors, utilizing neutron capture, with off-power harvesting during power reactor outages that did not add significant risk to the availability and reliability of electrical power production. There also has been more recent success for the neutron capture production of the medical isotopes lutetium-177 and molybdenum-99 in heavy water power reactors but with on-power harvesting during operation of the power reactor.

The design of a heavy water power reactor with its associated moderated thermal neutron flux, has limits on neutron capture capability due to neutron flux and the associated neutron energy levels available for the irradiation of a precursor that would be introduced within the power reactor. This results in a ceiling on the level of attainable specific-activity within the resulting radioisotope. These limits also restrict the possible choice of radioisotopes, where a required threshold level of neutron flux and/or energy is not available in a particular power reactor design. While power reactors are capable of producing radioisotopes via neutron capture, they may not be the most efficient or suitable for producing radioisotopes that require specific target materials or neutron energies that are not easily obtained within a power reactor.

For medical isotopes there are also pharmacopoeia requirements that must be met such as radio-nuclidic purity, radioactivity levels and other limits on levels of impurities or contaminants of both radioactive and non-radioactive compounds originating from the makeup of the precursor. Longer irradiation times needed for neutron capture in concert with lower levels of neutron flux and/or energy can result in higher unacceptable levels of non-desired radioactive compounds within the medical isotopes.

There is a need to ensure capacity to produce traditional medical isotopes currently being utilized as well as the next generation of medical isotopes that are focused on advanced technologies like targeted alpha-therapies and radiotheranostics, aiming for more precise and effective cancer treatments.

There at least remains a need for an augmented and/or expanded application of nuclear science processes for radioisotope production systems when installed in power reactors, and particularly in a heavy water power reactor, for example in a CANDU™ type heavy water power reactor, where it would allow versatility for a larger and broader production of radioisotopes. This would result in wider use and allowing for a greater selection for production of current and future medical isotopes of interest.

Before any embodiments are explained in detail, it is to be understood that the disclosure is not limited in its application to the details of construction and the arrangement of components set forth in the following description or illustrated in the accompanying drawings. The disclosure is capable of other embodiments and of being practiced or of being carried out in various ways.

### DEFINITIONS

Although the term “optimize” is used in the present disclosure, it should be understood that such term may be used to refer to improvements, tuning and refinements which may not be strictly limited to a maximum or minimum within any range.

The term “connected” or “coupled to” may include both direct coupling (in which two elements that are coupled to each other and contact each other) and indirect coupling (in which at least one additional element is located between the two elements).

Terms such as “up to”, “at least”, “greater than”, “less than”, “more than”, “or more”, and the like, include the number recited and such terms refer to ranges that can be subsequently broken down into sub-ranges. In the same manner, all ratios recited herein also include all sub-ratios falling within the broader ratio.

The singular forms “a,” “an,” and “the” include the plural reference unless the context clearly dictates otherwise. The term “and/or” means any one of the items, any combination of the items, or all of the items with which this term is associated.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

The term “precursor” refers to the chemical element or compound that is transformed into a desired radioisotope when exposed to a nuclear science process in the power reactor and may be in the form of a target. The radioisotope may be a medical isotope and/or an industrial isotope.

The term “target” refers to the part of a target bundle comprising the precursor that is bombarded with neutron flux and/or energy in a nuclear science process in a power reactor to produce the desired radioisotope.

The term “target bundle” may also comprise of reflective and/or multiplier material and/or be of mixed materials to allow for photonuclear reactions and/or fertile material and/or be in the presence of fissionable enriched uranium that would typically be low enriched uranium (LEU) fuel.

The term “target assembly” refers to a group of target bundles assembled together, for insertion into the reactor core.

The term “reactor core” refers to the central part of a power reactor where nuclear fission, the process of splitting atoms, takes place and generates heat. The term “inner volume” of the reactor core refers to the volume of the reactor core where fission occurs and comprises the portion of the guide tube of the system for producing radioisotopes according to this disclosure that extends into the reactor core.

Aspects of various embodiments are described through reference to the drawings.

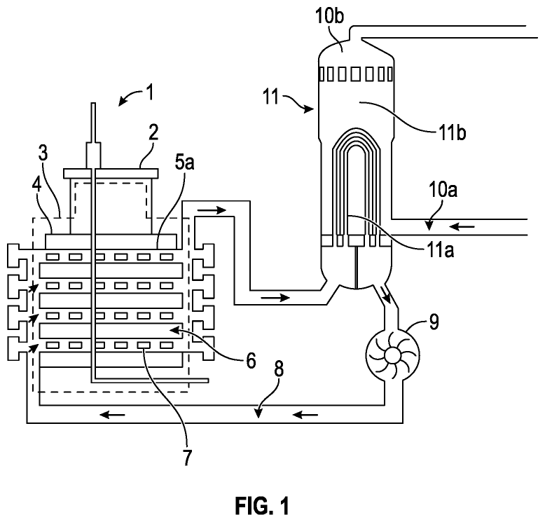

FIG. 1 is a simplified schematic view of the nuclear steam supply system of an example CANDU™ type heavy water reactor overlayed with a radioisotope production system 1 according to this disclosure. Although aspects of the invention are described with reference to the example CANDU™ type reactor for convenience, the invention is not limited to CANDU™ type reactors and may be useful outside this particular field as well. Returning to FIG. 1, heat is produced from the fission of the nuclear fuel 7, located within a plurality of fuel channel pressure tubes 5a that are fed by a recirculating pump 9 to move the heavy water primary coolant 8 through the nuclear fuel 7 and to the steam generator 11 primary side u-tubes 11a and back to the inlet of the recirculating pump 9. The heat is transferred from the heavy water primary coolant 8 within the steam generator 11 across the primary side u-tubes 11a to the secondary side 11b of the steam generator 11, where the light water feedwater 10a is turned into steam 10b. The plurality of fuel channel pressure tubes 5a pass though the shield tank 3 into the calandria vessel 4, that contains a heavy water moderator 6, and back out the shield tank 3 on the other side. Above the shield tank 3 is the reactivity mechanism deck 2 that supports the radioisotope production system 1.

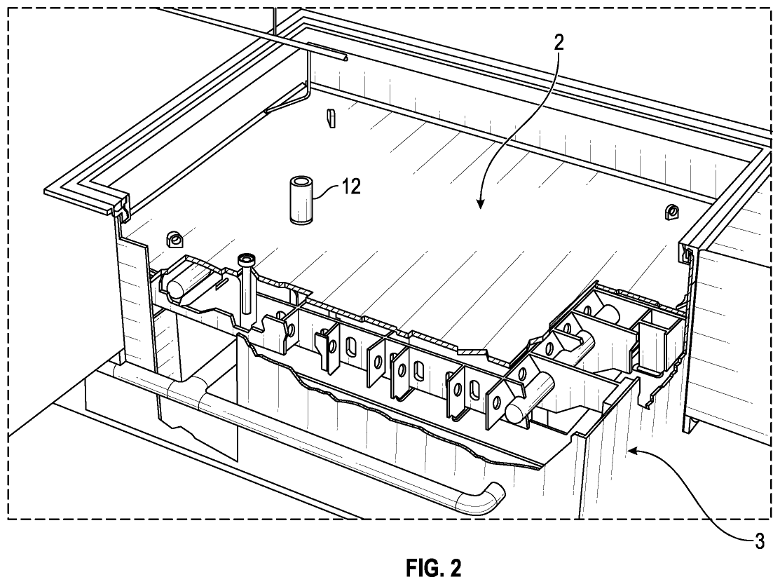

FIG. 2 is a cutaway view of a bare reactivity mechanism deck 2 of a CANDU™ type heavy water reactor showing a radioisotope production system nozzle 12. The reactivity mechanism deck 2 sits above the shield tank 3. In practice there could be up to, if not more than sixteen radioisotope production system nozzles 12 on a given reactivity mechanism deck 2, with their respective radioisotope production systems 1, all spaced out on the reactivity mechanism deck 2.

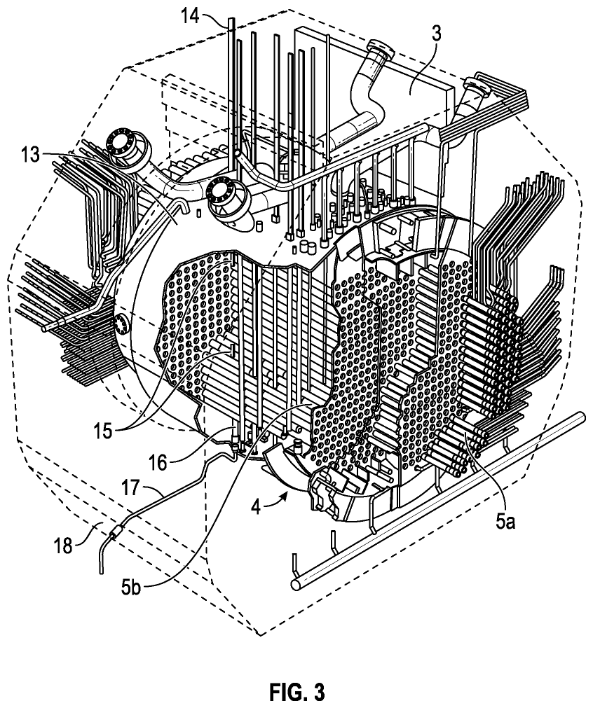

FIG. 3 is a perspective view of a CANDU™ type reactor showing the path within the reactor of the radioisotope production system guide tube extension 14 coming down through the top area of the shield tank 3, and passing down through the calandria shell 13, becoming the guide tube 15 within the calandria 4 and passing down in-between the fuel channel calandria tubes 5b. The fuel channel calandria tubes 5b contain the fuel channel pressure tubes 5a, wherein the fission heat is produced from the reactor core. The bottom of the guide tube 15 is connected to the coolant inlet nozzle 16 at the bottom of the calandria shell 13 and is fed coolant through an valve 18 and the coolant inlet line 17.

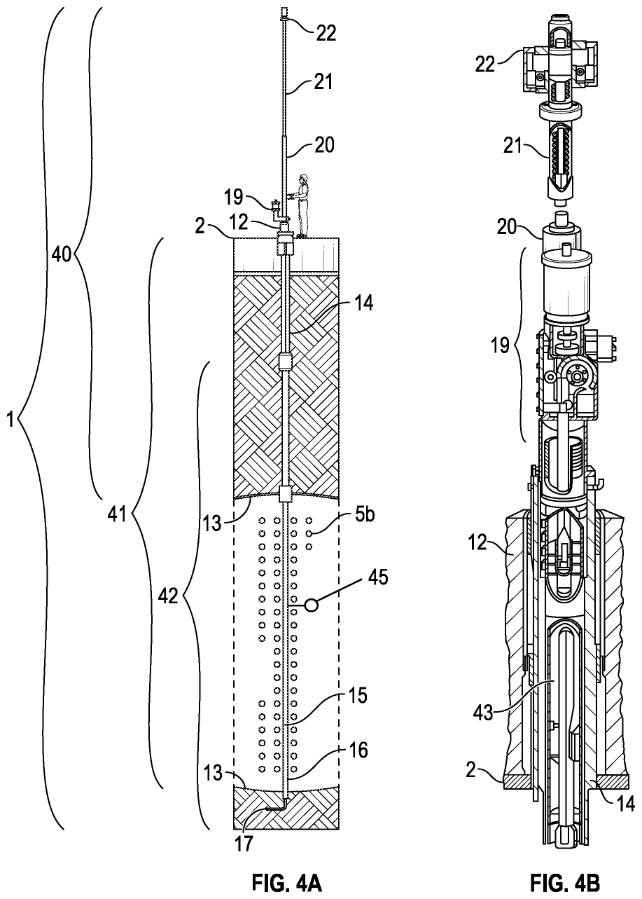

FIG. 4A is a cross-section schematic view of a CANDU™ type reactor comprising a system for producing radioisotopes 1, according to this disclosure positioned in relation to the calandria tubes 5b. FIG. 4B is an upper cutaway plan view of target delivery sub-system 40 and reactor integration sub-system 41 of the overall system for producing radioisotopes 1 shown in FIG. 4A. FIG. 4C is a lower cutaway plan view of target delivery sub-system 40, reactor integration sub-system 41 and cooling feed sub-system 42, including an example target assembly 26, all combined as the overall system for producing radioisotopes 1 shown in FIG. 4A. The target delivery sub-system 40, shown in its poised state, may utilize a rack and pinion drive mechanism, ball screw, or similar movement system which gives very positive control of its motion and location. As shown target delivery sub-system 40 is a rack and pinion drive mechanism, comprisescomprising limit switches 22, rack cover 21, rack stiffener 20, rack and pinion drive 19, shield plug 43, and push rod assembly 23. The reactor integration sub-system 41 comprises the radioisotope production system nozzle 12 located on the reactivity mechanism deck 2, guide tube extension 14, thimble 24 and guide tube 15 that connects to the coolant inlet nozzle 16 at the bottom of the calandria shell 13. The cooling feed sub-system 42 is fed cool moderator coolant through a valve 18 that flows through the coolant inlet line 17 that connects to the coolant inlet nozzle 16 at the bottom of the calandria shell 13. To address the resulting increase in heat load from the augmented and/or expanded application of nuclear science processes, the coolant is pumped up through the guide tube 15 and guide tube extension 14 where it exits through ports 44 into the annulus between the guide tube extension 14 and the thimble 24 and returns back into the calandria shell 13 through the coolant outlet nozzle 25 at the bottom of the thimble 24.

Again, it should be understood that although a CANDU™ type power reactor is illustrated in FIGS. 1, 2, 3, 4A, 4B and 4C, the invention may also apply to other types of power reactors.

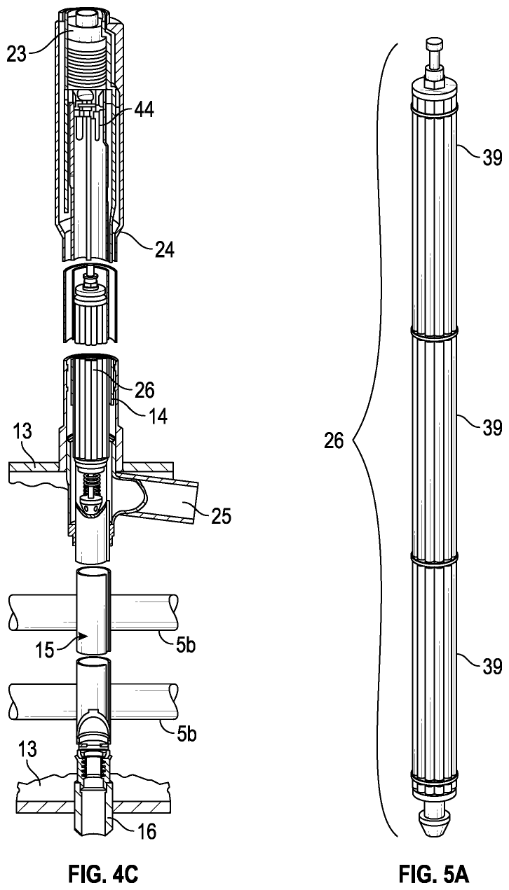

FIG. 5A is a perspective view of an example target assembly 26 with three target bundles 39. FIG. 5B is a cross-section schematic view of the target assembly 26 shown in FIG. 5A. FIG. 5C is a cutaway and cross section view of a target bundle 39 shown in FIG. 5A. A target bundle 39 may comprise a coupling shaft 27, spacer support flanges 28, a central support tube 29, and a spring retainer 30. A target bundle 39 may be made of a target bundle outer sub-assembly 31 and a target bundle inner sub-assembly 32 that includes outer rings 34 and inner rings 35, spacer rings 36, cladding tubes 33, and inner ring contents 37 and outer ring contents 38, both within cladding tubes 33, that are specific to the intended resulting radioisotope from the precursor and the intended nuclear science process to be used. In the illustrated example, at least one of the inner ring contents 37 and outer ring contents 38 comprises at least one target. The number of target assemblies and/or target bundles and/or targets and/or precursors inserted into a guide tube may differ from the illustrated example embodiment and could be more or less to match radioisotope demand based on production rates.

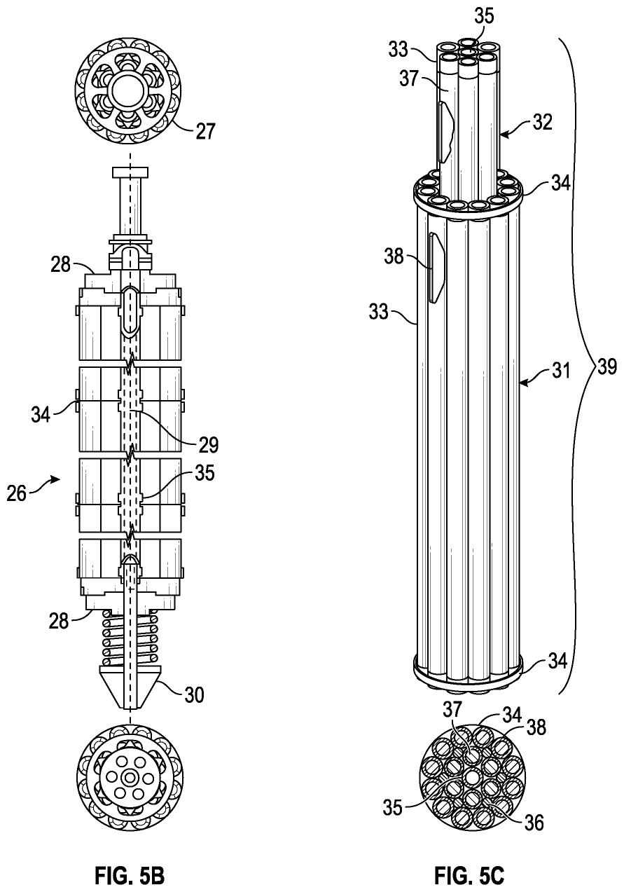

FIG. 6 shows a cross section of an example target bundle along the line A-A of FIG. 5C according to this disclosure. The radioisotope production system according to this disclosure is versatile in the number of types of species of radioisotopes that can be produced per nuclear science process method(s). Each bundle 39 may comprise different combinations of components in the elements of inner ring 37 and outer ring 38 in association with different method(s) of producing radioisotopes. For example, when neutron capture is used to produce radioisotopes, embodiments of bundle 39 may comprise an inner ring 37 of elements comprising a reflector to reflect neutrons, e.g. stainless steel, and an outer ring 38 of elements comprising a target comprising the precursor; or an inner ring 37 comprising a multiplier material, e.g. beryllium, and an outer ring 38 comprising a target comprising the precursor; or an inner ring 37 comprising fissionable material, such as a low enriched uranium (LEU) fuel, and an outer ring 38 comprising a target comprising the precursor. In another embodiment, when photonuclear is used to produce radioisotopes, embodiments of bundle 39 may comprise an inner ring 37 comprising a reflector and an outer ring 38 comprising a mixed target comprising a plurality of precursors; or an inner ring 37 comprising fissionable material, e.g. a LEU fuel, and an outer ring 38 comprising a mixed target comprising a plurality of precursors. In another embodiment, when fission is used to produce radioisotopes, embodiments of bundle 39 may comprise an inner ring 37 comprising a reflector, and an outer ring 38 comprising fissionable material (e.g. LEU target material) comprising the precursor; or an inner ring 37 comprising fissionable material, e.g. LEU fuel, and an outer ring 38 comprising a fissionable material (e.g. LEU target material) comprising the precursor. In another embodiment, when breeding is used to produce radioisotopes, embodiments of bundle 39 may comprise an inner ring 37 comprising a reflector and an outer ring 38 comprising a breeding target including fertile radioisotope material comprising the precursor; or an inner ring 37 comprising multiplier material and an outer ring 38 comprising a breeding target; or an inner ring 37 comprising an LEU fuel and an outer ring 38 comprising a breeding target.

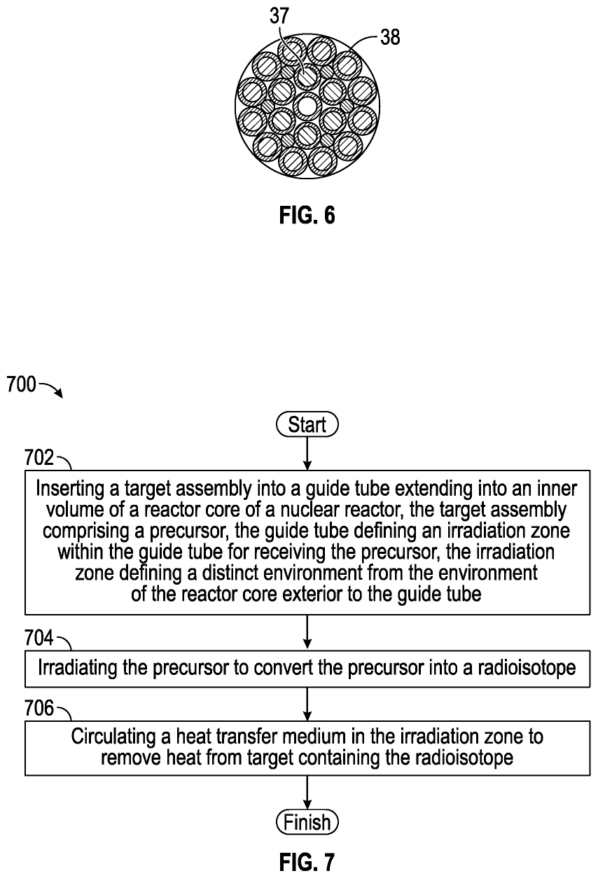

FIG. 7 is a schematic diagram illustrating a method 700 for radioisotope production in a power reactor.

At 702, the method comprises inserting a target, e.g. via a target assembly comprising the target, into a guide tube extending into an inner volume of a reactor core of a nuclear reactor, the target comprising a precursor, the guide tube defining an irradiation zone within the guide tube for receiving the precursor, the irradiation zone defining a distinct environment from the environment of the reactor core exterior to the guide tube.

At 704, the method comprises irradiating the precursor to convert the precursor into a radioisotope. In an embodiment, the precursor may be part of a target assembly comprising fissile material, which may permit irradiating the target assembly and precursor thereof with additive neutron flux and/or energy generated by fissile material within the guide tube. In an example, the target assembly may also comprise a sleeve comprising fissile material and/or moderator material. In another example, means to fine tune the neutron flux and/or energy may also be utilized. Continuing the example, the sleeve comprising fissile material and/or moderator material could encapsulate the target within the cladding to adjust the neutron energy ratios between thermal, epi-thermal and fast neutrons. The target assembly, including the sleeve or other means of adjusting neutron flux and/or energy, may be configured to provide a fine tuning about the peak specific-activity for the radioisotope. Peak specific-activity refers to the theoretical maximum amount of radioactivity per unit mass of a given isotope.

At 706, the method comprises circulating a heat transfer medium in the irradiation zone to remove heat from the target containing the generated radioisotope. The heat transfer medium may alternatively be another liquid or a gas. In an embodiment, the heat transfer medium could be, but not limited to, heavy water, argon, helium and/or light water. Utilizing non-water heat transfer mediums may also allow the use of a precursor which otherwise would react with water, such as a lithium-based precursor. In some embodiments, additional safety precautions may be taken, such as maintaining a pressure within the irradiation zone at a greater pressure than the pressure within reactor core external to the guide tube.

In an embodiment, each precursor may be configured to be converted into one or more radioisotopes such as, but not limited to: actinium-225, actinium-227, americium-241, bismuth-212, bismuth-213, cadmium-109, caesium-131, caesium-137, californium-252, carbon-14, cerium-141, chromium-51, cobalt-60, copper-64, copper-67, dysprosium-165, dysprosium-166, erbium-169, europium-152, europium-154, gadolinium-153, gold-198, holmium-166, iodine-125, iodine-131, iridium-192, iron-59, krypton-85, lead-212, lutetium-177, progenitor of lutetium-177, manganese-54, molybdenum-99, nickel-63, osmium-194, palladium-103, phosphorus-32, phosphorus-33, platinum-195m, plutonium-238, potassium-42, radium-223, rhenium-186, rhenium-188, rhodium-105, samarium-145, samarium-153, scandium-47, selenium-75, sodium-24, strontium-85, strontium-89, technetium-99m, terbium-161, thallium-204, thorium-226, thorium-227, thorium-228, thorium-229, thulium-170, tin-117m, tritium (H3), tungsten-188, xenon-127, xenon-133, ytterbium-169, ytterbium-175, ytterbium-177, yttrium-90, and yttrium-91.

In an embodiment, the delivery system may be one of pneumatic, hydraulic, mechanical or any combination thereof, adding to its versatility, as an example, other commercially available systems could be incorporated into the system and method described in this disclosure to create additional neutron flux and/or energy from reflector, multiplier, fissile or fertile material positioned within the system which is in addition to that created by the reactor core. This allows the ability to provide additive neutron flux and/or energy to convert the precursor. By providing an additive source of neutron flux and/or energy for producing radioisotopes, reduction and moderation of the fluxes in the rest of the power reactor may be prevented or mitigated, and higher specific-activity and/or higher threshold isotopes can be produced.

In another embodiment, the target assembly includes an additional fission and/or moderator sleeve, or other means to fine tune the neutron flux and/or energy, as part of the target assembly where the sleeve is configured to promote peak radioisotope specific-activity in the radioisotope produced from the precursor. In other words, instead of simply using neutron capture as a method of irradiation, utilizing augmented and/or expanded application of nuclear science processes, targets could additionally include sleeves that may optimize local target flux and/or energy for peak isotope specific-activity of the created radioisotope.

In another embodiment, the heat transfer medium may be another liquid or gas. In an embodiment, the heat transfer medium could be, but not limited to, heavy water, argon, helium, and/or light water.

### Controller

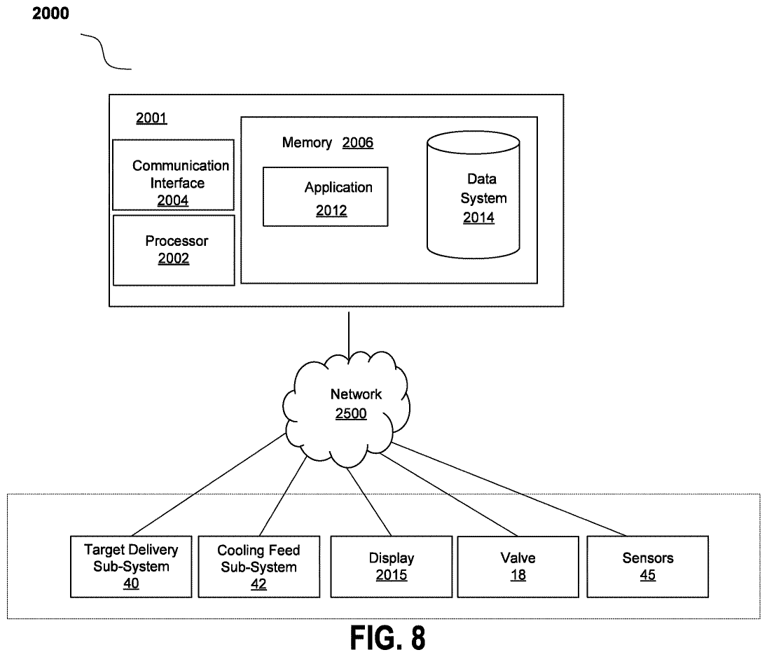

FIG. 8 shows a generalized schematic view of example system 2000 for controlling a system to produce a radioisotope, e.g. a medical isotope or industrial isotope. System 2000 may comprise controller 2001, described herein. Controller 2001 includes a processor 2002 configured to implement processor readable instructions that, when executed, configure the processor 2002 to conduct operations described herein. The processor 2002 may be a microprocessor or microcontroller, a digital signal processing (DSP) processor, an integrated circuit, a field programmable gate array (FPGA), a reconfigurable processor, a programmable read-only memory (PROM), or combinations thereof. Controller 2001 may include a communication interface 2004 to communicate with other computing or sensor devices, to access or connect to network resources, or to perform other computing applications by connecting to a network (or multiple networks) capable of carrying data. In some examples, the communication interface 2004 may include one or more busses, interconnects, wires, circuits, and/or any other connection and/or control circuit, or combination thereof. The communication interface 2004 may provide an interface for communicating data between the system 2000 and a display 2015.

Controller 2001 may also comprise connections for communicating with any of target delivery sub-system 40, cooling feed sub-system 42, display 2025, valve 18, sensor 45, e.g. pressure, temperature, and/or flow sensors; according to this disclosure to transmit setpoint(s) or receive data such as open/closed, pressure, temperature, flowrate, status, among other data.

Controller 2001 may be coupled to a data system 2014 for storing system data and/or may be configured to communicate with cloud services, or any other digital data servers. Data system 2014 may also comprise a universal asynchronous receiver-transmitter (UART) to allow communication with other devices, e.g. smartphone or a computer, for transmitting data for analysis and/or storage. UART may include or be coupled to a wireless transceiver for wireless communication with such other devices, e.g., by way of infra-red, Bluetooth, Wi-Fi, or the like. Network 2500 may include any wired or wireless communication path, such as an electrical circuit. In some embodiments, the network 2500 may include one or more busses, interconnects, wires, circuits, and/or any other connection and/or control circuit, or a combination thereof. In some embodiments, the network 2500 may include a wired or a wireless wide area network (WAN), local area network (LAN), a combination thereof, or the like. In some embodiments, the network 2500 may include a Bluetooth® network, a Bluetooth® low energy network, a short-range communication network, or the like.

Controller 2001 may include memory 2006. The memory 2006 may include one or a combination of computer memory, such as static random-access memory (SRAM), random-access memory (RAM), read-only memory (ROM), electro-optical memory, magneto-optical memory, erasable programmable read-only memory (EPROM), and electrically-erasable programmable read-only memory (EEPROM), Ferroelectric RAM (FRAM) or the like.

The memory 2006 may store an application 2012 including processor readable instructions for conducting operations described herein. In some examples, the application 2012 may include operations for controlling a system for producing a radioisotope in a nuclear reactor, e.g. a heavy water nuclear reactor, according to this disclosure.

In an embodiment, application 2012 may include operations for sending data to the delivery system to move the precursor from the first position outside the inner volume of the reactor core to the second position within the inner volume of the reactor core. In an example, the nuclear reactor core has a height defined by a distance between a bottom and top of the reactor core, and the second position may be anywhere along the height of the reactor core, e.g. within 25% of the height from the bottom, between 25%-75% of the height from bottom, and/or between 75%-100% of the height from the bottom of the reactor core.

In an embodiment, application 2012 may include operations for sending data to the cooling system to circulate the heat transfer medium through the irradiation zone of the guide tube. In an embodiment, the cooling system comprises: a valve configured to control a flowrate of the heat transfer medium through the irradiation zone of the guide tube, and at least one of a temperature sensor and pressure sensor configured to sense temperature of the guide tube within the irradiation zone. In an embodiment, application 2012 may include operations for sending data to the valve to circulate the heat transfer medium to maintain at least one of a desired temperature and pressure of the guide tube within the irradiation zone.

In an embodiment, the precursor is a first precursor; and application 2012 may include operations for sending data to the delivery system to move a second precursor from the first position outside the inner volume of the reactor core to the second position within the inner volume of the reactor core to irradiate both the first and second precursors concurrently. In another embodiment, application 2012 may include operations for sending data to the delivery system to move the first precursor from the second position within the inner volume of the reactor core to the first position outside the inner volume of the reactor core after the first precursor is converted into a radioisotope. In this example, each guide tube may comprise multiple precursors which may be irradiated concurrently after which when one of the precursors is converted into a radioisotope it can be remove while the remaining precursor can remain in the irradiation zone to be converted into a radioisotope.

In an embodiment, application 2012 may include operations for sending data to the delivery system to remove the target assembly comprising the radioisotope from the reactor core. In an example, the nuclear reactor, and reactor core thereof, may still be operating to produce power when the target assembly is removed from the reactor core.

### Alternate Embodiments

The above description is meant to be exemplary only, and one skilled in the relevant arts will recognize that changes may be made to the embodiments described without departing from the scope of the invention disclosed. The present disclosure may be embodied in other specific forms without departing from the subject matter of the claims. The present disclosure is intended to cover and embrace all suitable changes in technology. Modifications which fall within the scope of the present invention will be apparent to those skilled in the art, in light of a review of this disclosure, and such modifications are intended to fall within the appended claims. Also, the scope of the claims should not be limited by the preferred embodiments set forth in the examples, but should be given the broadest interpretation consistent with the description as a whole.

As can be understood, the detailed embodiments described above and illustrated are intended to be examples only. The invention is defined by the appended claims.

The claims are not intended to include, and should not be interpreted to include, means-plus- or step-plus-function limitations, unless such a limitation is explicitly recited in a given claim using the phrase(s) “means for” or “step for,” respectively.

1. A system for producing radioisotopes in a nuclear reactor having a reactor core, the system comprising:
a guide tube defining an irradiation zone within the guide tube for receiving a precursor, the guide tube extending into an inner volume of the reactor core, and the irradiation zone defining a distinct environment from an environment of the reactor core exterior to the guide tube;
a cooling system for circulating a heat transfer medium through the irradiation zone of the guide tube; and
a delivery system for moving the precursor from a first position outside the inner volume of the reactor core to a second position within the inner volume of the reactor core, wherein the first position is outside the inner volume of the reactor core.

2. The system of claim 1, wherein the precursor is configured to be converted into one or more radioisotopes selected from: actinium-225, actinium-227, americium-241, bismuth-212, bismuth-213, cadmium-109, caesium-131, caesium-137, californium-252, carbon-14, cerium-141, chromium-51, cobalt-60, copper-64, copper-67, dysprosium-165, dysprosium-166, erbium-169, europium-152, europium-154, gadolinium-153, gold-198, holmium-166, iodine-125, iodine-131, iridium-192, iron-59, krypton-85, lead-212, lutetium-177, progenitor of lutetium-177, manganese-54, molybdenum-99, nickel-63, osmium-194, palladium-103, phosphorus-32, phosphorus-33, platinum-195m, plutonium-238, potassium-42, radium-223, rhenium-186, rhenium-188, rhodium-105, samarium-145, samarium-153, scandium-47, selenium-75, sodium-24, strontium-85, strontium-89, technetium-99m, terbium-161, thallium-204, thorium-226, thorium-227, thorium-228, thorium-229, thulium-170, tin-117m, tritium (H3), tungsten-188, xenon-127, xenon-133, ytterbium-169, ytterbium-175, ytterbium-177, yttrium-90, yttrium-91.

3. The system of claim 1, wherein the precursor is part of a target assembly, wherein the target assembly is configured to provide an additive neutron flux and/or energy to convert the precursor into a radioisotope, preferably the target assembly comprises a sleeve comprising fissile material and/or a moderator material, wherein the sleeve defines the precursor, wherein the target assembly is configured to provide peak radioisotope specific-activity for the radioisotope.

4. (canceled)

5. (canceled)

6. The system of claim 3, wherein the precursor is a first precursor; and wherein the target assembly comprises a second precursor configured to convert into a different radioisotope than the first precursor.

7. The system of claim 3, wherein the target assembly comprises one or more target bundles including a plurality of targets, wherein the precursor is a first precursor and the target assembly is a first target assembly, wherein the target bundle comprises an inner ring of elements and an outer ring of elements, wherein one of the inner ring or the outer ring comprises the first precursor, wherein the other of the inner ring or outer ring comprises at least one element comprising a reflector, a multiplier, or fissionable material.

8. The system of claim 7, wherein:
the inner ring of elements comprises the reflector and the outer ring of elements comprises the precursor; or
the inner ring of elements comprises the multiplier material and the outer ring of elements comprises the precursor; or
the inner ring of elements comprises fissionable material and the outer ring comprises the precursor; or
the precursor is a first precursor, and wherein the inner ring of elements comprises the reflector and the outer ring comprises a plurality of precursors, the plurality of precursors comprising the first precursor; or
the inner ring of elements comprises the fissionable material and the outer ring of elements comprises the plurality of precursors, the plurality of precursors comprising the first precursor; or
the inner ring of elements comprises the reflector and the outer ring of elements comprises the fissionable material and the precursor; or
the inner ring of elements comprises the fissionable material and the outer ring of elements comprises the fissionable material and the precursor; or
the inner ring of elements comprises the reflector and the outer ring of elements comprises a breeding target including fertile radioisotope material comprising the precursor; or
the inner ring of elements comprises the multiplier material and the outer ring of elements comprises the breeding target including fertile radioisotope material comprising the precursor; or
the inner ring of elements comprises the fissionable material and the outer ring of elements comprises the breeding target including fertile radioisotope material comprising the precursor.

9. (canceled)

10. The system of claim 1, wherein the heat transfer medium is at least one of heavy water, argon, helium, and light water.

11. The system of claim 1, comprising a controller configured to:
send data to the delivery system to move the precursor from the first position outside the inner volume of the reactor core to the second position within the inner volume of the reactor core, and
send data to the cooling system to circulate the heat transfer medium through the irradiation zone of the guide tube.

12. (canceled)

13. The system of claim 11, wherein the cooling system comprises:
a valve configured to control a flowrate of the heat transfer medium through the irradiation zone of the guide tube, and
at least one of a temperature sensor and pressure sensor configured to sense temperature of the guide tube within the irradiation zone;
wherein the controller sends data to the valve to circulate the heat transfer medium to maintain at least one of a desired temperature and pressure of the guide tube within the irradiation zone.

14. The system of claim 11, wherein the precursor is a first precursor, and wherein the controller is configured to:
send data to the delivery system to move a second precursor from the first position outside the inner volume of the reactor core to the second position within the inner volume of the reactor core to irradiate both the first and second precursors concurrently.

15. The system of claim 11, wherein the controller is configured to:
send data to the delivery system to move the first precursor from the second position within the inner volume of the reactor core to the first position outside the inner volume of the reactor core after the precursor is converted into a radioisotope.

16. A nuclear reactor comprising the system of claim 1, the nuclear reactor comprising:
a reactor core enclosure;
a plurality of pressure tubes in the reactor core enclosure including fuel bundles, heavy water primary coolant flowing from outside of the reactor core enclosure through the plurality of pressure tubes, the reactor core enclosure including heavy water moderator separated from the plurality of pressure tubes;
and a reactivity mechanism deck positioned above the reactor core enclosure, the reactivity mechanism deck including a port extending therethrough, the port housing the guide tube configured to convert the precursor into a radioisotope upon exposure to one or more nuclear science processes.

17. The nuclear reactor as recited in claim 1, wherein the delivery system is a rack and pinion mechanical delivery system.

18. The nuclear reactor of claim 1, wherein the delivery system may be at least one of a pneumatic delivery system, hydraulic delivery system, or mechanical delivery system, or any combination thereof.

19. A method for producing a radioisotope, the method comprising:
inserting a target assembly into a guide tube extending into an inner volume of a reactor core of a nuclear reactor, the target assembly comprising a precursor, the guide tube defining an irradiation zone within the guide tube for receiving the precursor, the irradiation zone defining a distinct environment from the environment of the reactor core exterior to the guide tube;
irradiating the precursor to convert the precursor into a radioisotope; and
circulating a heat transfer medium in the irradiation zone to remove heat from the target assembly, preferably the heat transfer medium is at least one of heavy water, argon, helium, and light water.

20. The method of claim 19, removing the target assembly comprising the radioisotope from the reactor core.

21. The method of claim 19, wherein the radioisotope comprises: actinium-225, actinium-227, americium-241, bismuth-212, bismuth-213, cadmium-109, caesium-131, caesium-137, californium-252, carbon-14, cerium-141, chromium-51, cobalt-60, copper-64, copper-67, dysprosium-165, dysprosium-166, erbium-169, europium-152, europium-154, gadolinium-153, gold-198, holmium-166, iodine-125, iodine-131, iridium-192, iron-59, krypton-85, lead-212, lutetium-177, progenitor of lutetium-177, manganese-54, molybdenum-99, nickel-63, osmium-194, palladium-103, phosphorus-32, phosphorus-33, platinum-195m, plutonium-238, potassium-42, radium-223, rhenium-186, rhenium-188, rhodium-105, samarium-145, samarium-153, scandium-47, selenium-75, sodium-24, strontium-85, strontium-89, technetium-99m, terbium-161, thallium-204, thorium-226, thorium-227, thorium-228, thorium-229, thulium-170, tin-117m, tritium (H3), tungsten-188, xenon-127, xenon-133, ytterbium-169, ytterbium-175, ytterbium-177, yttrium-90, and yttrium-91.

22. The method of claim 19, comprising irradiating the precursor with additive neutron flux and/or energy within the guide tube.

23. The method of claim 22, wherein the target assembly comprises a sleeve comprising fissile material and/or moderator material, wherein the sleeve defines the precursor, wherein the target assembly is configured to provide peak specific-activity for the radioisotope.

24. (canceled)

25. The method of claim 19, comprising maintaining a first pressure within the guide tube at a greater pressure than a second pressure within the reactor core external to the guide tube.
